(19) United States
(12) Patent Application Publication
(10) Pub. No.: US 2022/0002996 A1
(43) Pub. Date: Jan. 6, 2022

(54) METHOD FOR MANUFACTURING A CONSTRUCTION PANEL

(71) Applicant: RC Panels HoldingBV, Lemelerveld (NL)

(72) Inventor: Carlos KLIEN, Lemelerveld (NL)

(21) Appl. No.: 17/292,371

(22) PCT Filed: Nov. 4, 2019
(86) PCT No.: PCT/NL2019/050723

§ 371 Date: May 7, 2021

(30) Foreign Application Priority Data
Nov. 9, 2018 (NL) 1043074

(51) Int. Cl. E04C 2/284; B32B 5/18; B32B 27/30; B32B 3/30; B32B 21/02; B32B 21/08; B32B 21/04; B32B 27/12; E04F 13/08

(52) U.S. Cl. CPC E04C 2/284; B32B 2262/101; B32B 27/302; B32B 3/30; B32B 21/02; B32B 21/08; B32B 21/047; B32B 27/12; E04F 13/0873; B32B 2266/0228; B32B 2255/102; B32B 2255/26; B32B 2607/00; B32B 2307/304; B32B 5/18

(57) ABSTRACT

Method for manufacturing on industrial scale of complete, highly reliable, flexible and accurate construction panels that are lightweight and have a very high R-value, wherein the processing is performed, under the control of a digital construction data file, by means of digitally controlled processing devices, such as milling and/or cutting devices. Portions of the construction panel from which the covering layer has been removed by the processing devices (such as the sides of recesses for door and window frames etcetera and optionally milled gutter slots) and portions of the construction panel of which the cover layer requires extra protection, such as portions below ground level, under control of the digital construction data file, are provided with a rigid and highly reliable protective layer of polyurea, polyester or epoxy by means of digitally controlled spraying devices. One or more delta robots can be used for mounting cladding elements such as a brick strip, which robots can be moved by means of the X-Y displacement system above the construction panel controllable from the digital construction data file.

The invention relates to a method for manufacturing a construction panel intended for use as a self-supporting wall panel or roof panel having a high R-value.

Such a construction panel is known, inter alia, from NL1040849C in the name of the applicant, where in particular the application of the rigid cover layers to the foamed insulating material is discussed. The present invention includes a further elaboration of what is disclosed in NL1040849C. The present invention also relates to a method for entirely industrially manufacturing construction panels, of which the structure and the applications are disclosed in more detail in another patent application of the applicant, which has as subject “Construction panel for use as self-supporting wall panel or roof panel”.

According to the present invention a method is provided for manufacturing a construction panel intended for use as a self-supporting wall panel or roof panel having a high R-value, comprising the following steps:
providing a digital construction data file with the desired construction data of the construction panel, obtained by scanning an existing building and/or obtained from a design (in particular with the aid of a digital design/drawing program);
providing a device for manufacturing a construction panel comprising a base layer of foamed material of, for example, EPS, provided with a thin, rigid reinforcement cover layer on one side, hereinafter referred to as the first cover layer, and on the other side also provided with a thin, rigid reinforcement cover layer, hereinafter referred to as the second cover layer. The layers are either directly applied to the base layer (e.g. by gluing), or by means of an intermediate layer of a material, which is suitable for receiving screws,
providing means, which are adapted for covering the transverse surfaces (side surfaces) of the construction panel,
   wherein the transverse surfaces of the construction panel, not being covered by the cover layers, are covered with a layer of polyurea, polyester or epoxy (industrially) applied thereupon, which serves for hermetically sealing off the transverse surfaces not covered by the cover layers against environmental influences such as moisture, vermin, mechanical damage, etcetera.

The respective first and second cover layers (plates) can be made of, for example, fibre-reinforced, thermosetting plate material such as glass-fibre-reinforced polyester plate, but can also be made of OSB (“Oriented Strand Board”; https://en.wikipedia.org/wiki/Oriented_Beach_Board) or, in particular when using the construction panels according to the invention as roofing sheets, can be made of steel sheet.

In many cases, construction panels are sought-after that (must be) are covered with covering elements such as brick strips, giving the construction panels more the appearance of a traditionally built (masonry) outside wall. For the manufacture of such construction panels, the method according to the invention comprises the provision of means, which are arranged for applying (for example by gluing) covering elements, such as in particular brick strips, in a predetermined pattern to the first cover layer of the construction panel.

One or more delta robots (https://en.wikipedia.org/wiki/delta_robot) may be used for applying the covering elements to the first cover layer, which robots are capable of rapidly and very accurately providing covering elements in predetermined patterns on the (horizontal) construction panel which, for example by an adhesive layer previously applied to the construction panel, are adhered to the construction panel. The delta robots may, for example, be mounted on or assembled with an X-Y displacement system controllable from the digital construction data file, which system is located above the underlying construction panel and which is used to move the delta robot(s) to the designated areas, where the covering elements are provided.

Often, construction panels are required, that are provided with one or more recesses for e.g. a door or a window, wherein the method comprises the provision of means, which are adapted to provide such recesses in the material of the construction panel, as well as means adapted for covering the transverse surfaces of said recesses by applying thereupon a layer of polyurea, polyester or epoxy.

The required recesses may be profiled for the purpose of receiving and/or supporting a construction element to be placed and/or mounted into the recess, for example a windowpane, panel or (window or door) frame.

In that case, the method comprises the provision of means, which are adapted to provide one or more recesses in the construction panel, which recesses are profiled, as seen in cross-section, as well as means, which are arranged for covering the profiled transverse surfaces of said recesses by applying thereto a layer of polyurea, polyester or epoxy.

The means for accurately customizing/tailoring the construction panel at the factory and/or for providing the one or more profiled and/or non-profiled recesses into the construction panel, preferably comprise one or more robotic milling cutters and/or cutting devices, for example installed in or assembled with an X-Y displacement system controllable from the digital construction data file, which system is located above the underlying construction panel and which accurately and quickly positions and further controls the milling and/or cutting device(s).

The method according to the invention may comprise the provision of means that are arranged for slotting or milling of one or more portions of the outer surface of the base layer of foamed material and/or of the relevant cover layer, as well as may comprise means adapted to cover the surface of said one or more portions by applying thereto a layer of polyurea, polyester or epoxy. The result of this method is a construction panel with (partly) an external relief/profile with a decorative and/or functional purpose (for example as an integrated roof gutter), in which the slotted or milled portions are industrially provided with a layer of a polyurea, polyester, epoxy protective against environmental influences.

The method according to the invention may also comprise the provision of means that are arranged for covering a portion of the construction panel that is intended to be installed below ground level by applying a layer of polyurea, polyester or epoxy to that portion (on top of the already present cover layer). In this way, it is achieved that the construction panel is provided with an (additional) protective layer at the portion of the construction panel, that is positioned into the soil, below ground level. The extra protective layer of polyurea, polyester or epoxy serves as a substitute for a so-called “side board” which, in traditional building construction, is fitted against the bottom portion of an outside wall.

According to the invention, the means for applying a layer of polyurea, polyester or epoxy onto the transverse surfaces at the outer sides of the construction panel, respectively, onto the transverse surfaces, profiled or non-profiled, of the recesses in the construction panel, respectively, onto the one or more slotted or milled portions of the outer surface of the construction panel, respectively, onto a portion of the construction panel intended to be installed below ground level, preferably, comprise robotic spraying devices for polyurea, polyester or epoxy in sprayable state. The spraying devices may be mounted on or assembled with the X-Y displacement system above the construction panel during manufacture, the system being controllable from the construction data file.

The sprayable state of polyurea, polyester or epoxy is obtained, for example, by mixing and heating the polyurea, polyester or epoxy components during the spraying process (“hot spray”); see also https://en.wikipedia.org/wiki/Polyurea, https://www.youtube.com/watch?v=djCBkmPpZlc, http://www.kunststofcoatings.nl/materiaal-en-techniek/processing of polyurea/.

Summarized, the present invention provides a method by which construction panels can be manufactured entirely industrially, in a very reliable manner, flexibly and accurately. The panels are lightweight and have a very high R-value (see https://en.wikipedia.org/wiki/Thermal_resistance), in which the processing steps, under the control of a digital construction data file, are performed by digitally controlled one or more processing devices, such as milling and/or cutting devices. Portions of the construction panel from which the covering layer has been removed by the processing devices (such as the sides of recesses for door frames and window frames etcetera and optional milled-out roof gutter slots etcetera), as well as portions of the construction panel of which the covering layer requires additional protection (in particularly portions below ground-level) are provided with rigid and highly reliable protective layers of polyurea, polyester or epoxy under control of the digital construction data file by means of digitally controlled spraying devices. For providing covering (cladding) elements such as a brick strip, use can be made of one or more delta robots, which can also be moved by means of the X-Y displacement system above the construction panel, controllable from the digital construction data file.

1. Method for manufacturing a building panel intended for use as a self-supporting wall panel or roof panel having a high R-value, comprising the following steps:
providing a digital construction data file with the desired construction data of the construction panel, obtained by scanning of an existing building and/or obtained from design;
providing a device for manufacturing a construction panel comprising a base layer of foamed material of, for example, EPS, provided with a thin, rigid reinforcement cover layer on one side, hereinafter referred to as the first cover layer, and on the other side also provided with a thin, rigid reinforcement cover layer, hereinafter referred to as the second cover layer, wherein the layers are either directly applied to the base layer or by means of an intermediate layer of a material, which is suitable for screws,
providing means, which are adapted for covering the transverse surfaces (side surfaces) of the construction panel, not being covered by the cover layers, by applying thereupon a layer of polyurea, polyester or epoxy

2. Method according to claim 1, wherein means are provided that are arranged for applying covering elements, such as in particular brick strips, to the first cover layer in a predetermined pattern.

3. Method according to claim 2, wherein the means for applying the covering elements upon the first cover layer comprise one or more delta robots.

4. Method according to anyone of the preceding claims, comprising:
providing means that are arranged for providing one or more recesses in the material of the construction panel for, e.g., a door or a window, as well as providing means which are arranged for covering the transverse surfaces of the recesses by applying thereupon a layer of polyurea, polyester or epoxy.

5. Method according to claim 4, comprising:
providing means that are arranged for applying one or more recesses in the construction panel, which recesses, as seen in cross-section, are profiled for the purpose of receiving and/or supporting a construction element to be mounted or supported in said recess, such as a windowpane, panel or frame, as well as providing means adapted to cover the profiled transverse surfaces of said recesses by applying thereupon a layer of polyurea, polyester or epoxy.

6. Method according to anyone of the preceding claims, wherein the means for customizing the construction panel and/or for providing the one or more recesses, profiled or non-profiled, into the construction panel, comprise one or more robotic milling and/or cutting devices.

7. Method according to anyone of the preceding claims, comprising:
providing means adapted for slotting or milling of one or more portions of the outer surface of the base layer of foamed material and/or of the relevant cover layer, as well as providing means adapted for covering the surface of the one or more portions by applying thereto a layer of polyurea, polyester or epoxy.

8. Method according to anyone of the preceding claims, comprising:
providing means adapted for covering a portion of the construction panel intended to be installed below ground level by applying a layer of polyurea, polyester or epoxy.

9. Method according to anyone of the preceding claims, wherein the means for applying a layer of polyurea, polyester or epoxy onto the transverse surfaces of the construction panel, respectively, onto the transverse surfaces, profiled or non-profiled, of the recesses, respectively, onto the one or more slotted or milled portions of the outer surface of the base layer of foamed material and of the respective cover layer, respectively, onto a portion of the construction panel that is intended to be installed below ground level, comprise one or more robotic sprayer devices for polyurea, polyester or epoxy in a sprayable state.

10. Method according to anyone of the preceding claims, providing an X-Y displacement system above the construction panel to be manufactured, which system is controllable from the digital construction data file, the system being arranged to displace the one or more devices to the designated area of the construction panel for processing the construction panel, and/or to displace one or more devices to the designated area of the construction panel for applying the polyurea, polyester or epoxy, and/or to displace one or more devices to the designated area of the construction panel for applying covering elements to the construction panel.

11. Device for carrying out the method according to anyone of the preceding claims, comprising an X-Y displacement system controllable from a digital construction data file, which system is arranged above the location of the construction panel to be manufactured, and which system is arranged to displace one or more devices for processing the construction panel and/or to displace one or more devices for applying the polyurea, polyester or epoxy and/or to displace one or more devices for applying covering elements to the designated areas of the construction panel.
